(19) United States
(12) Patent Application Publication
(10) Pub. No.: US 2023/0139347 A1
(43) Pub. Date: May 4, 2023

(54) PER-EMBEDDING-GROUP ACTIVATION QUANTIZATION

(71) Applicant: QUALCOMM Incorporated, San Diego, CA (US)

(72) Inventors: Yelysei BONDARENKO, Amsterdam (NL); Markus NAGEL, Amsterdam (NL); Tijmen Pieter Frederik BLANKEVOORT, Amsterdam (NL)

(21) Appl. No.: 17/976,683

(22) Filed: Oct. 28, 2022

Related U.S. Application Data
(60) Provisional application No. 63/273,857, filed on Oct. 29, 2021.

(51) Int. Cl. G06F 40/40; G06N 3/04; G06N 3/08

(52) U.S. Cl. CPC G06F 40/40; G06N 3/04; G06N 3/08

(57) ABSTRACT

A processor-implemented method for providing per-embedding-group activation quantization includes receiving sequential data at a first layer of a transformer neural network. The sequential data is processed via the first layer of the transformer neural network to generate an activation tensor. The activation tensor is split into multiple groups of embeddings. Each of the embeddings groups has a different set of quantization parameters. Each of the embedding groups is quantized separately based on the corresponding quantization parameters of the different set of quantization parameters. The quantized embedding groups are multiplied with a set of weights to generate an output.

### CROSS-REFERENCE TO RELATED APPLICATION

The present application claims the benefit of U.S. Provisional Patent Application No. 63/273,857, filed on Oct. 29, 2021, and titled “PER-EMBEDDING-GROUP ACTIVATION QUANTIZATION,” the disclosure of which is expressly incorporated by reference in its entirety.

### FIELD OF DISCLOSURE

Aspects of the present disclosure generally relate to quantization in neural networks.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Edge devices such as smartphones are widely used. Given the many useful applications of neural networks, there is increasing demand for use on edge devices and for personalized services for such edge devices. However, edge devices have limited computational resources and generalized models may utilize more complex networks and more computation.

Transformer-based architectures have become the de-facto standard models for a wide range of natural language processing tasks. However, their memory footprint and high latency are prohibitive for efficient deployment and inference on resource-limited devices.

### SUMMARY

The present disclosure is set forth in the independent claims, respectively. Some aspects of the disclosure are described in the dependent claims.

In an aspect of the present disclosure, a processor-implemented method is provided. The method includes receives sequential data at a first layer of a transformer neural network. The method also includes processing the sequential data via attention layers of the transformer neural network to generate an activation tensor. Additionally, the method includes splitting the activation tensor into multiple groups of embeddings. Each group of embeddings has a different set of quantization parameters. The method also includes quantizing each of the groups of embeddings separately based on corresponding quantization parameters of the different set of quantization parameters. Further, the method includes multiplying the quantized group of embeddings with a set of weights to generate an output.

In an aspect of the present disclosure, an apparatus is provided. The apparatus includes a memory and one or more processors coupled to the memory. The processor(s) are configured to receive sequential data at a first layer of a transformer neural network. The processor(s) are also configured to process the sequential data via attention layers of the transformer neural network to generate an activation tensor. In addition, the processor(s) are configured to split the activation tensor into multiple groups of embeddings. Each group of embeddings has a different set of quantization parameters. The processor(s) are also configured to quantize each of the groups of embeddings separately based on corresponding quantization parameters of the different set of quantization parameters. Further, the processor(s) are configured to multiply the quantized group of embeddings with a set of weights to generate an output.

In an aspect of the present disclosure, an apparatus is provided. The apparatus includes means for receiving sequential data at a first layer of a transformer neural network. The apparatus also includes means for processing the sequential data via attention layers of the transformer neural network to generate an activation tensor. Additionally, the apparatus includes means for splitting the activation tensor into multiple groups of embeddings. Each group of embeddings has a different set of quantization parameters. The apparatus also includes means for quantizing each of the groups of embeddings separately based on corresponding quantization parameters of the different set of quantization parameters. Further, the apparatus includes means for multiplying the quantized group of embeddings with a set of weights to generate an output.

In an aspect of the present disclosure, a non-transitory computer readable medium is provided. The computer readable medium has encoded thereon program code. The program code is executed by a processor and includes code to receive sequential data at a first layer of a transformer neural network. The program code also includes code to process the sequential data via attention layers of the transformer neural network to generate an activation tensor. Additionally, the program code includes code to split the activation tensor into multiple groups of embeddings. Each group of embeddings has a different set of quantization parameters. The program code also includes code to quantize each of the groups of embeddings separately based on corresponding quantization parameters of the different set of quantization parameters. Furthermore, the program code includes code to multiplying the quantized group of embeddings with a set of weights to generate an output.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIG. 2 is a block diagram illustrating an exemplary software architecture that may modularize artificial intelligence (AI) functions.

FIG. 3 is a block diagram illustrating an exemplary attention layer of a transformer architecture, in accordance with aspects of the present disclosure.

FIG. 4 is a block diagram illustrating a comparison of per-tensor quantization and per-embedding-group quantization, in accordance with aspects of the present disclosure.

FIG. 5 is a block diagram illustrating an example implementation of per-embedding-group quantization using per-tensor operations, in accordance with aspects of the present disclosure.

FIG. 6 is a flow diagram illustrating an example method for providing per-embedding-group activation quantization, in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Recently, transformer architectures have shown improvement in language modeling and natural language processing (NLP) tasks. Based on the conventional transformer architectures such as bi-directional encoder representations from transformers (BERT), robustly optimized BERT approach (RoBERTa), XLNet, Transformer-XL, and the generative pre-trained transformer (GPT) family of transformers, language models may be pre-trained from large corpora of unlabeled text. Accordingly, such transformer architectures have become popular building blocks in conventional NLP pipelines, as well as in other areas such as computer vision and audio processing.

Despite providing performance improvements in many applications, pre-trained transformer-based models may be extremely large, sometimes exceeding billions of parameters, for example. Hence, efficient deployment of such transformer-based models on resource-constrained embedded systems including mobile devices (e.g., smartphone) and Internet of Things (IoT) devices, and even some systems in data centers, is challenging due to increased latency and prohibitively large memory footprint and energy consumption.

One effective method to address this problem is neural network quantization. Neural network quantization reduces memory consumption by using low-bit precision for weight and activation tensors. In addition, neural network quantization may reduce inference time and improve energy efficiency by employing low-bit fixed-point arithmetic instead of floating-point arithmetic.

Quantization, however, may introduce additional noise in the neural network that may lead to a reduction in the model's accuracy as well as an increase in computational complexity. Accordingly, to address these and other issues, aspects of the present disclosure are directed to improved quantization for transformer-based models. In accordance with aspects of the present disclosure, activation quantization may be provided on a per-embedding-group basis. In some aspects, quantization-aware training and/or post-training quantization may also be applied. Additionally, in some aspects, uniform affine quantization and static activation ranges, which are either estimated in post-training quantization (PTQ) or learned during quantization-aware training (QAT), may be employed.

In some aspects, post-training quantization may be applied. In post-training quantization, a pre-trained full precision 32-bit network may be converted directly into a fixed-point network without the original training pipeline. One step in post-training quantization is finding quantization ranges for each quantizer. For example, a static range estimation determines quantization parameters for the network by passing a few batches of calibration data through the transformer model before inference. In doing so, a more efficient inference is obtained because quantization parameters are known in advance and fixed. Other range estimators, such as current minimum-maximum, which uses the full dynamic range of the tensor as the estimate, running minimum-maximum, which uses the exponential moving average of the minimum and maximum over multiple batches, or the mean squared error, which uses quantization parameters that minimize the mean squared error between quantized and floating-point tensors, for example, may be used.

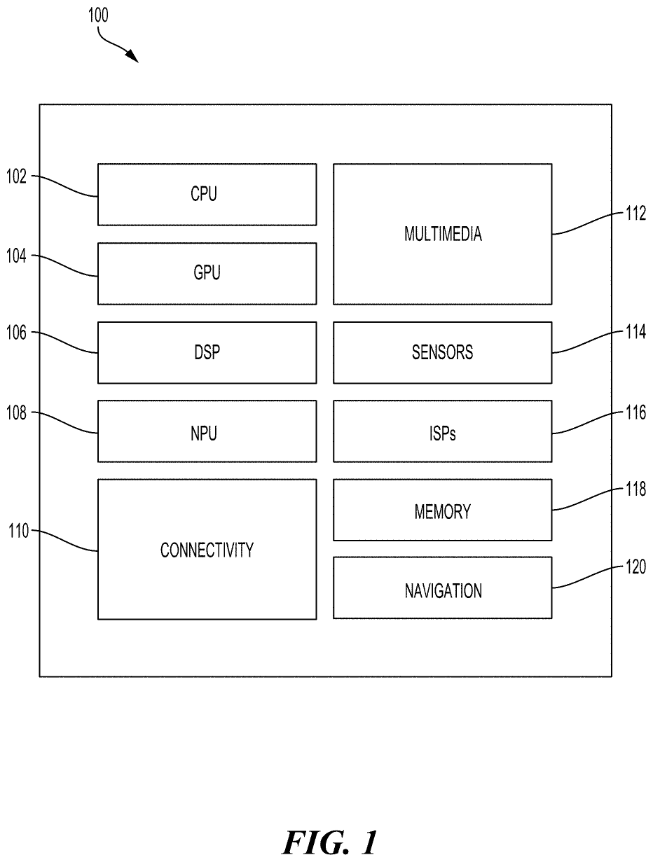

FIG. 1 illustrates an example implementation of a system-on-a-chip (SOC) 100, which may include a central processing unit (CPU) 102 or a multi-core CPU configured for per-embedding-group activation quantization. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive sequential data at a first layer of a transformer neural network. The general-purpose processor 102 may also include code to process the sequential data via the first layer of the transformer neural network to generate an activation tensor. The general-purpose processor 102 may also include code to split the activation tensor into multiple groups of embeddings. Each group of embeddings has a different set of quantization parameters. The general-purpose processor 102 may also include code to quantize each of the groups of embeddings separately based on corresponding quantization parameters of the different set of quantization parameters. The general-purpose processor 102 may further include code to multiply the quantized group of embeddings with a set of weights to generate an output.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

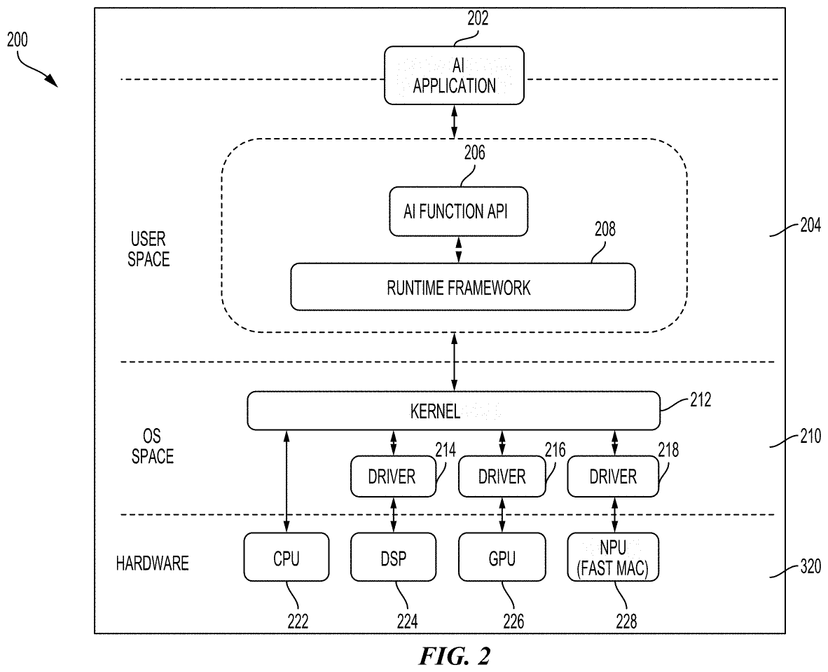

FIG. 2 is a block diagram illustrating an exemplary software architecture 200 that may modularize artificial intelligence (AI) functions. Using the architecture, applications may be designed that may cause various processing blocks of a system-on-a-chip (SOC) 220 (for example a CPU 222, a DSP 224, a GPU 226, and/or an NPU 228) to support adaptive rounding as disclosed for post-training quantization for an AI application 202, according to aspects of the present disclosure.

The AI application 202 may be configured to call functions defined in a user space 304 that may, for example, provide for the detection and recognition of a scene indicative of the location in which the device currently operates. The AI application 202 may, for example, configure a microphone and a camera differently depending on whether the recognized scene is an office, a lecture hall, a restaurant, or an outdoor setting such as a lake. The AI application 202 may make a request to compiled program code associated with a library defined in an AI function application programming interface (API) 206. This request may ultimately rely on the output of a deep neural network configured to provide an inference response based on video and positioning data, for example.

A run-time engine 208, which may be compiled code of a runtime framework, may be further accessible to the AI application 202. The AI application 202 may cause the run-time engine, for example, to request an inference at a particular time interval or triggered by an event detected by the user interface of the application. When caused to provide an inference response, the run-time engine may in turn send a signal to an operating system in an operating system (OS) space, such as a Linux Kernel 212, running on the SOC 220. The operating system, in turn, may cause a continuous relaxation of quantization to be performed on the CPU 222, the DSP 224, the GPU 226, the NPU 228, or some combination thereof. The CPU 222 may be accessed directly by the operating system, and other processing blocks may be accessed through a driver, such as a driver 214, 216, or 218 for, respectively, the DSP 224, the GPU 226, or the NPU 228. In the exemplary example, the deep neural network may be configured to run on a combination of processing blocks, such as the CPU 222, the DSP 224, and the GPU 226, or may be run on the NPU 228.

The application 202 (e.g., an AI application) may be configured to call functions defined in a user space 204 that may, for example, provide for the detection and recognition of a scene indicative of the location in which the device currently operates. The application 202 may, for example, configure a microphone and a camera differently depending on whether the recognized scene is an office, a lecture hall, a restaurant, or an outdoor setting such as a lake. The application 202 may make a request to compiled program code associated with a library defined in a SceneDetect application programming interface (API) 206 to provide an estimate of the current scene. This request may ultimately rely on the output of a differential neural network configured to provide scene estimates based on video and positioning data, for example.

A run-time engine 208, which may be compiled code of a Runtime Framework, may be further accessible to the application 202. The application 202 may cause the run-time engine, for example, to request a scene estimate at a particular time interval or triggered by an event detected by the user interface of the application. When caused to estimate the scene, the run-time engine may in turn send a signal to an operating system 210, such as a Linux Kernel 212, running on the SOC 220. The operating system 310, in turn, may cause a computation to be performed on the CPU 222, the DSP 224, the GPU 226, the NPU 228, or some combination thereof. The CPU 222 may be accessed directly by the operating system, and other processing blocks may be accessed through a driver, such as a driver 214-218 for a DSP 224, for a GPU 226, or for an NPU 228. In the exemplary example, the differential neural network may be configured to run on a combination of processing blocks, such as a CPU 222 and a GPU 226, or may be run on an NPU 228.

As described, transformer architectures have shown improvement in language modeling and natural language processing (NLP) tasks. However, pre-trained transformer-based models may be extremely large. As such, efficient deployment of transformer-based models on resource-constrained embedded systems including mobile devices (e.g., smartphone) and Internet of Things (IoT) devices, and even some systems in data centers, is challenging due to increased latency, a prohibitively large memory footprint, and increased energy consumption.

Accordingly, aspects of the present disclosure are directed to improved quantization for transformer-based models. In accordance with aspects of the present disclosure, activation quantization may be provided on a per-embedding-group basis.

In some aspects, quantization-aware training and/or mixed precision post-training quantization may be applied. Additionally, in some aspects, uniform affine quantization and static activation ranges, which are either estimated in post-training quantization (PTQ) or learned during quantization-aware training (QAT), may be employed.

Quantization may provide a powerful way to decrease computational time in memory consumption of neural networks. Quantization uses low-bit representations for weight and/or activation tensors. By moving from a 32-bit representation to an eight-bit representation, for example, the memory overhead of storing the weight or activation tensors may be decreased by a factor of four, while the computational cost for matrix multiplication operations may be reduced quadratically by a factor of 16. Low-bit fixed-point representations such as INT8, for example, may further reduce the energy consumption because the fixed-point operations may be more efficient than their floating-point counterparts. However, exact latency improvements and energy savings may be highly dependent on the target hardware.

One conventional quantization approach is uniform affine or asymmetric quantization. The uniform affine or asymmetric quantization is defined by bit width b ∈ [symbol] , scale factor s ∈ [symbol] ₊, and zero-point z ∈ [symbol] . The quantization process may be performed in floating-point. For instance, quantizing a real value tensor x may be performed by mapping it to an unsigned integer grid as follows:

$${x}^{( z )} = clip ( ⌊ \frac{x}{s} ⌉ + z ; 0 , {2}^{b} - 1 ) , \qquad ( 1 )$$

where clip is the clipping function that rounds values in an array that are above a maximum limit to the maximum limit and rounds values that are below a minimum limit to the minimum limit. The real-valued input x may be approximately recovered by performing a de-quantization operation:

\hat{x}=q(x; s, z, b)=s(x^{(z)}−z)≈x. (2)

In symmetric quantization, a quantization grid may be limited to be symmetric around z. In some conventional quantization approaches, a single set of quantization parameters may be used for each tensor. This is known as per-tensor quantization. Unlike these conventional approaches, aspects of the present disclosure may increase the quantization granularity by defining separate quantization parameters (which may be referred to as “quantizers”) for individual segments (e.g., subsets) of a tensor. In doing so, aspects of the present disclosure may advantageously improve the accuracy of the transformer model, but with the cost of an additional compute and memory overhead.

An input and an output of a feed forward network may have dramatically different dynamic ranges. On one hand, using a high dynamic range for small ranged values leads to a loss in representation (e.g., high rounding error). On the other hand, a small dynamic range for large ranged values leads to a very high clipping error. For such large differences in dynamic ranges, it is difficult to find the right trade-off between these two types of errors. Moreover, a correlation of outliers with special (e.g., SEP) tokens exists.

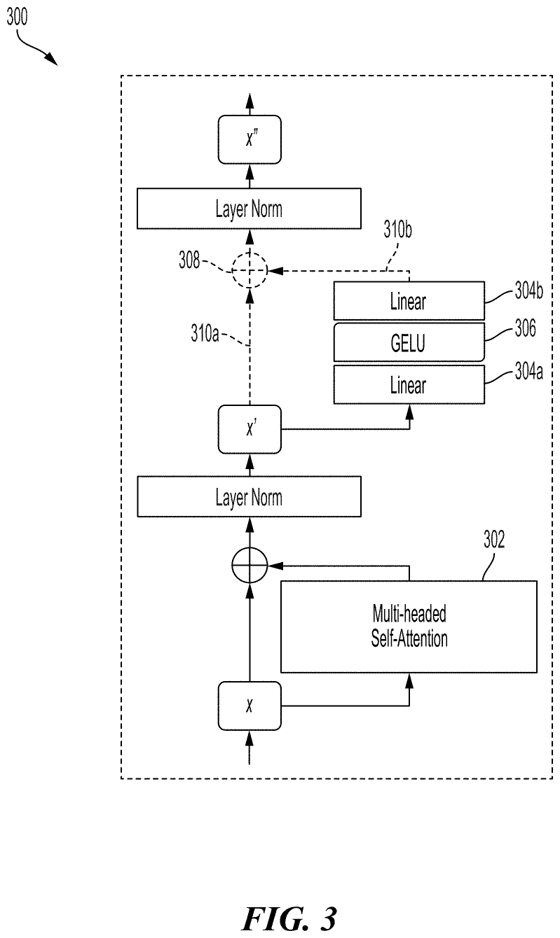

FIG. 3 is a block diagram illustrating an example attention layer 300 of a transformer architecture, in accordance with aspects of the present disclosure. Referring to FIG. 3, the example attention layer 300 may be included in bi-directional encoder representations from a transformer (BERT)-type transformer model, for instance. However, the present disclosure is not so limiting and other transformer models may also be used. The attention layer 300 may include a multi-headed self-attention layer 302, linear layers 304a, 304b, and a Gaussian error linear unit (GELU) 306. An input x may be received at the attention layer 300. The input may, for example, include sequential data such as a natural language sentence or image data of a video. The sequence of data input to a transformer network is in the form of a sequence of tokens, including so-called special tokens, such as the sentence-separator special token, [SEP]. The input data may be processed via the multi-headed self-attention layer 302. The multi-headed self-attention layer 302 may generate an encoded representation for each portion (e.g., a word in a sentence) of the input. The encoded representations for each of the portions may be combined and output. The output may, for instance, provide an indication of a relationship between the portions (e.g., words or images) of the input.

The output of the multi-headed self-attention layer 302 may be subjected to an element-wise addition with the input x and normalized via the layer norm to generate a hidden activation tensor x′. The hidden activation tensor x′ may be received and processed via the linear layers 304a, 304b with the application of the GELU 306 activation function. The output of the linear layer 304b is supplied via a residual connection 310b to a summing node 308, which performs an element-wise addition with the hidden activation tensor x′ supplied via a residual connection 310a. The output of the summing node 308 is normalized and the value x″ is supplied to a subsequent layer of the transformer. One source of the additional noise when conventional quantization approaches have been applied is the element-wise addition of the hidden activation tensor x′ and the output of the linear layer 304b (e.g., output activation) supplied via the residual connections 310a, 310b, as seen by the dashed lines in FIG. 3. Although weight quantization may contribute very little to the quantization error (e.g., noise), activation quantization may contribute to the degradation.

The performance (e.g., processing speed and efficiency) of the quantized transformer model may also be improved by increasing the quantization granularity. One issue with quantization in transformer models is presented by quantization of activations. That is, it is challenging to quantize transformer activations because of a considerable mismatch between the dynamic ranges in the residual connections. The strongest outliers of the mismatched dynamic ranges may only be present in very few embedding dimensions. Accordingly, individual embedding dimensions or groups of embedding dimensions may have distinct quantization parameters.

In transformer models, such as BERT-type models (e.g., the attention layer shown in FIG. 3), an intermediate hidden activation tensor x may have a shape or dimensions (B, T, d), where B is the batch size (batch dimension), T is the sequence length (token dimension), and d is the number of embedding dimensions (e.g., d=768 for a BERT-base transformer). In accordance with aspects of the present disclosure, distinct quantization parameters may be applied to different embedding dimensions or groups of embedding dimensions. For example, distinct scaling factors and zero-points may be applied per embedding dimension of an activation tensor rather than having two scalars for an entire activation tensor. As such, the quantization parameters may be collectively denoted by vectors s, z ∈ [symbol] ^{d}, where s represents the scaling factor and z represents the zero-points. The rest of the quantization machinery works as before, including range estimation, with the only difference being that Equations (1) and (2) are now broadcasting along the last dimension. The term “broadcasting” may be considered to mean that these operations are defined by replicating or distributing the smaller arrays s and z across the missing dimensions of x (e.g., the first two in this case). It is the effect of copying those vectors B*T times to create the tensor of the same shape, but may be done more efficiently in libraries (e.g., without copying). Accordingly, the activation quantization issues may be reduced because the outlier embedding dimensions may no longer dominate the ranges of other embedding dimensions.

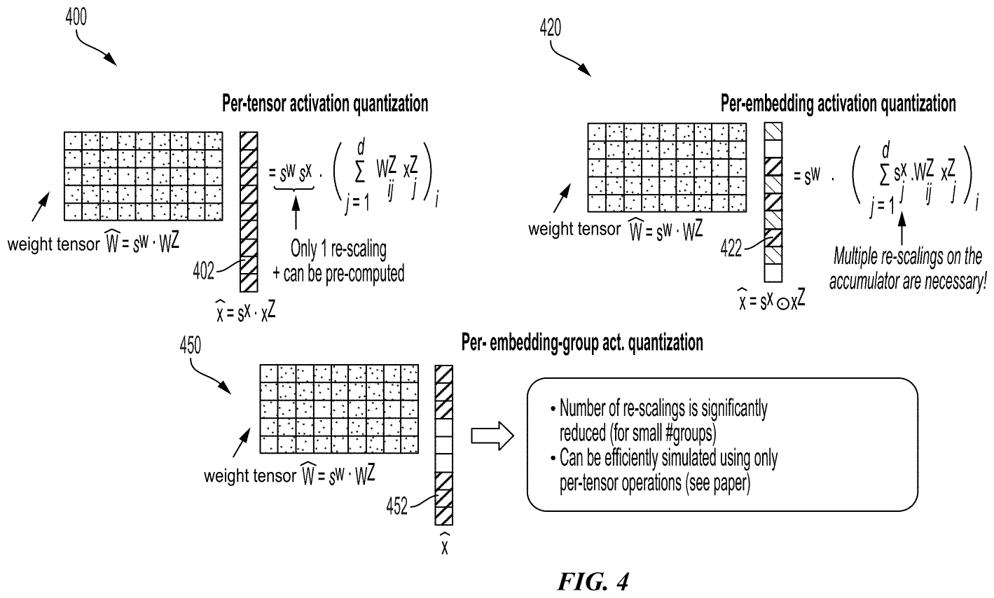

FIG. 4 is a block diagram illustrating a comparison of per-tensor quantization and per-embedding-group quantization, in accordance with aspects of the present disclosure. Referring to FIG. 4, in a per-tensor quantization 400, the entire activation tensor 402 is quantized according to the same quantization parameters. The quantization parameters may, for instance, include a scaling factor s. In the example of FIG. 4, per-tensor quantization is used for each of the weight matrices Ŵ.

On the other hand, in per-embedding quantization 420, an activation tensor 422 may be split into multiple embedding groups. The number or size of the embedding groups may be set according to design preference, for example. For instance, activation tensor 422 may be split into embedding groups such that each element in an activation tensor 422 is an embedding dimension (d). Each embedding dimension (d) of the activation tensor 422 has a different set of quantization parameters such as a scaling factor and zero-point. Although the per-embedding quantization 420 may provide improved accuracy over the per-tensor quantization 400, per-embedding quantization may have increased latency due to the multiple different rescaling operations for each embedding dimension.

In some aspects, full per-embedding activation quantization may lead to a more expensive computational graph. This may be illustrated by considering a matrix-vector multiplication Wx, which in case of per-tensor quantization (and assuming z=0) for both weights and activations may be computed as follows:

$$\hat{W} \hat{x} = ( {s}^{w} \cdot {W}^{( ℤ )} ) ( {s}^{x} \cdot {x}^{( ℤ )} ) = {s}^{w} {s}^{x} \cdot {( {\sum }_{j = 1}^{d} {W}_{ij}^{( ℤ )} {x}_{j}^{( ℤ )} )}_{i} , \qquad ( 3 )$$

where i and j are indices representing the column and row of the weight matrix, respectively.

In Equation (3), common scaling factors s^{w}, s^{x} may be factored out of the summation. The sum may then be more efficiently calculated using integer-only arithmetic. In the case of per-embedding activation quantization, \hat{x}=s^{x}⊙ [symbol] , where ⊙ is an element-wise product or Hadamard product operator, the matrix-vector multiplication becomes instead:

$$\hat{W} \hat{x} = {s}^{w} \cdot {( {\sum }_{j = 1}^{d} {s}_{j}^{x} \cdot {W}_{ij}^{( ℤ )} {x}_{j}^{( ℤ )} )}_{i} , \qquad ( 4 )$$

In Equation (4), it may no longer possible to factor out the scaling factor from the summation and perform a single re-scaling of the result. Instead, repeated re-scalings may be performed on the accumulator.

To alleviate the overhead due to repeated re-scaling, aspects of the present disclosure apply per-embedding-group (PEG) quantization. That is, the activation tensor may be split into groups. In some aspects, the activation tensor may be split into K evenly sized groups along the embedding dimension (d). The quantization parameters may be shared among elements in the same group:

\hat{x}=[ [symbol] ·[ [symbol] . . . [symbol] ], s₂^{x}·[ [symbol] ₊₁, . . . , sₖ^{x}·[ . . . [symbol] ]], (9)

where [ . . . ] denotes a concatenation operation. Accordingly, the number of re-scaling operations may be significantly reduced from d to K, where d is the number of dimensions (e.g., elements) in the activation tensor and K is the number of embedding groups.

Referring again to FIG. 4, in a per-embedding-group quantization 450, an activation tensor 452 is divided into groups of embeddings. The groups of embeddings may each have the same size. As shown in FIG. 4, the activation tensor 452 is divided into three groups, each of which includes three embeddings. Although three groups of embeddings are shown, this is merely an example for ease of understanding and not limiting. Rather, any number of embedding groups may be provided at any size, according to design preference, for instance. Similar to the activation tensor 422, each of the embedding groups of the activation tensor 452 may have a different set of quantization parameters.

In some aspects, a deterministic range-based permutation of the embedding dimensions may be employed to capture all outliers in the same group. Some calibration data may be passed through an un-quantized (e.g., full precision) network. The dynamic range rⱼ:=max(x_{:,:,j})−min(x_{:,:,j}) may be determined for each embedding dimension j. Then, K evenly sized groups may be defined based on indices in the function arg sort (r). The arg sort function returns indices that sort an array. During the range estimation phase, a separate quantization range may be determined for each group. In some aspects, the sorting and grouping may beneficially be performed only once before the range estimation phase and deployment to the target.

Additional advantages of the per-embedding-group quantization include that it has a negligible memory overhead, introducing only d+2·3·K extra parameters per attention layer (e.g., permutation indices and scale, and zero points per group for feed-forward network input, output, and sum), which may be significantly less than (e.g., 0.04%) the total size of a BERT-type transformer model.

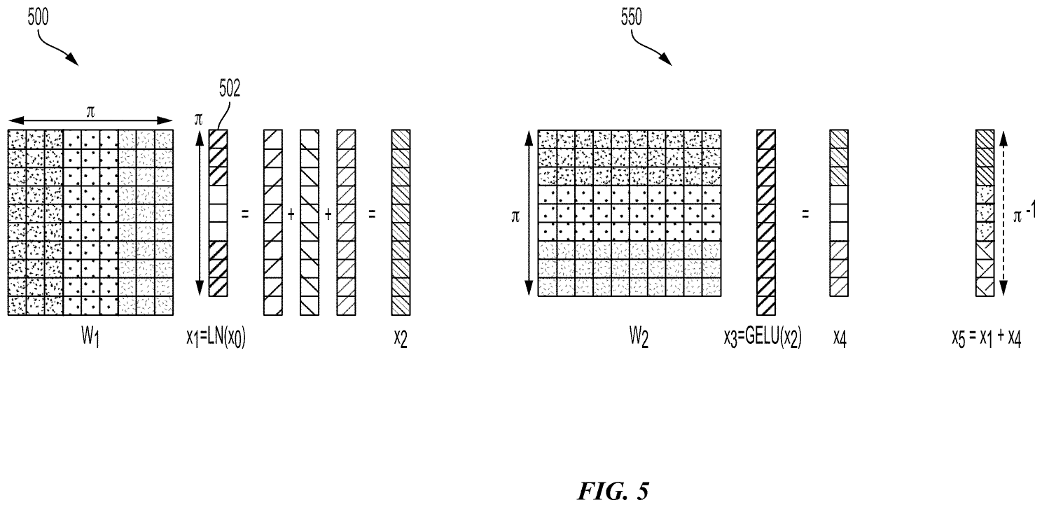

FIG. 5 is a block diagram illustrating example implementations 500, 550 of per-embedding-group quantization using per-tensor operations, in accordance with aspects of the present disclosure. In some aspects, per-embedding-group quantization may be simulated using per-tensor operations. That is, in some aspects in which per-embedding-group quantization is not natively supported on all target devices, the per-embedding-group quantization may be implemented using only per-tensor quantization operations.

Per-embedding-group quantization with permutation may still be simulated on hardware that only supports per-tensor operations. The same permutation for a feed-forward network input, output, and sum may be shared because the outliers in the output dominate the outliers from the input. The permutation-equivariant properties of LayerNorm and linear layers may be used such that weights are permuted accordingly, before inference. The output of the first LayerNorm may be permuted initially before proceeding as described above. Thereafter, an inverse permutation may be performed before applying the next LayerNorm.

Referring to FIG. 5, an intermediate activation (x₁) 502, is divided into multiple embedding groups. Before quantizing the intermediate activation 502, the intermediate activation 502 may be split based on the embedding groups into K individual tensors. The weight matrix W₁ may also be split into portions corresponding to the K individual tensors. In FIG. 5, the columns of the weight matrix W₁ are split into K corresponding portions (e.g., subsets), each portion may be considered smaller matrices. In some aspects, a range-based permutation may be applied. For instance, as shown in FIG. 5, the activation 502 and the weight matrix W₁ may be subject to range-based permutation (indicated by the symbol π). The range-based permutation may be applied prior to splitting the activation 502 and weight matrix W₁ according to the embedding groups. As such, the arg sort function may be applied to capture the dynamic range outliers in the same embedding group. A matrix multiplication operation may be performed between the portions of the weight matrix and the corresponding embedding groups, the results of which may be element-wise summed to generate the activation tensor x₂.

The range-based permutation may be performed at a subset of the layers of the transformer network. A shown in the example implementation 550, the range-based permutation is applied to weight matrix W₂. Rows of the weight matrix W₂ may be permuted according to the range-based permutation and split into K smaller matrices. On the other hand, the range-based permutation is not applied to activation tensors x₂ and x₃. In addition, activation tensors x₂ and x₃ are not divided into groups. That is, in some aspects, a subset of the activation tensors may split into embedding groups. Matrix-vector multiplication operations may be conducted between the portions of W₂ and the activation tensor x₃. The outputs of matrix-vector multiplications between portions of the weight matrix W₂ and x₃ (collectively denoted by x₄), are summed with the corresponding output portions x₁ to produce activation tensor x₅. An inverse permutation may be applied to x₅. In some aspects, embedding groupings and permutations may be applied to a subset of layers of the transformer neural network. For instance, the remaining layers of the transformer neural network (not shown) may perform computations to process an input such as sequence data without permutation or dividing subsequent activation tensors into embedding groups. Additionally, although permutation may be shared for different activation tensors within each attention layer, a different permutation may be performed for different attention layers, within the same transformer neural network.

Different parts of a transformer model such as a BERT-type model may not be equally sensitive to quantization noise. Thus, selecting a higher bit-width for sensitive tensors (e.g., 16-bit or 32-bit) may lead to increased accuracy while efficiently keeping all the other tensors in 8-bit or lower. For instance, in a first example, 16-bit activation quantization may be employed for problematic activation tensors, such as the residual sum tensor after the feed-forward network. Higher bit-width may provide a model with sufficient precision to represent both input and output of the feed-forward network as well as their sum. Additionally, in some aspects low-bit (e.g., two to four bit) weight and token embedding quantization may be performed to further reduce the transformer model size (e.g., by more than 8×) with a minimal loss in accuracy.

Another quantization approach is known as quantization-aware training. Quantization-aware training allows a model to better adapt introduced quantization noise than post-training quantization, at the cost of an increased training duration as well as a dependence on labeled data and hyper-parameter searches. In quantization-aware training, gradients through non-differentiable quantization steps may be approximated using a straight through estimator, for example. Ranges for both weights and activations may be set using post-training quantization range estimators or may be learned jointly with the weights during training.

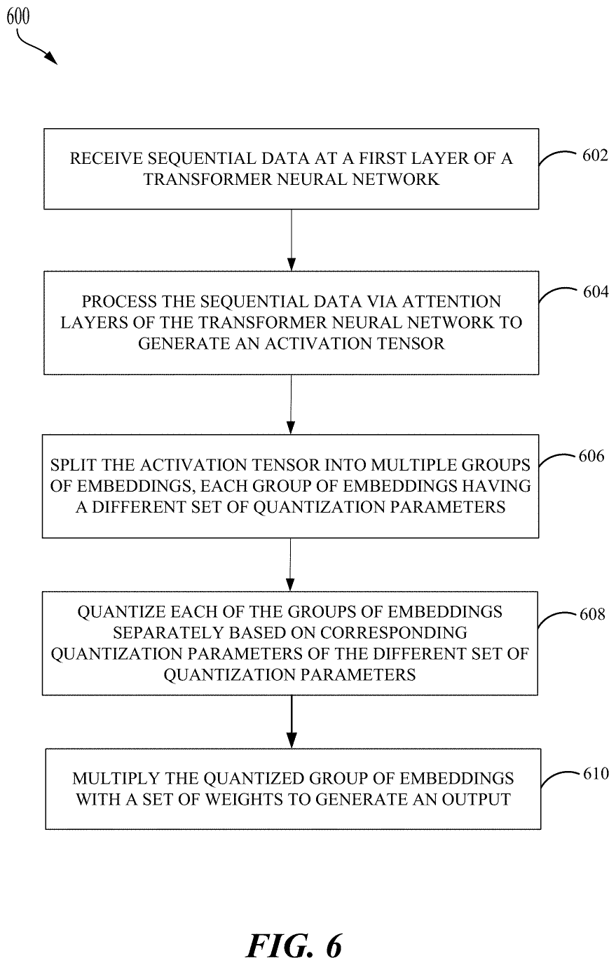

FIG. 6 is a flow diagram illustrating an example process 600 for providing per-embedding-group activation quantization, in accordance with aspects of the present disclosure. As shown in FIG. 6, at block 602, the process 600 receives sequential data at a first layer of a transformer neural network. For instance, as shown in FIG. 3, an input x may be received at the attention layer 300. The input may, for example, be sequential data such as a natural language sentence or image data of a video.

At block 604, the process 600 processes the sequential data via attention layers of the transformer neural network to generate an activation tensor. For example, as described with reference to FIG. 3, the input data may be processed via the multi-headed self-attention layer 302. The output of the multi-headed self-attention layer 302 is subjected to an element-wise addition with the input and normalized via the layer norm to generate a hidden activation tensor x.

At block 606, process 600 splits the activation tensor into multiple groups of embeddings, each group of embeddings having a different set of quantization parameters. As described, for example, with reference to FIG. 4, in per-embedding quantization 420, an activation tensor 422 may be split into multiple embedding groups. The number or size of the embedding groups may be set according to design preference for example. For instance, activation tensor 422 is split into embedding groups such that each element in an activation tensor 422 is an embedding. Each embedding of the activation tensor 422 has a different set of quantization parameters such as a scaling factor and zero-point.

At block 608, the process 600 quantizes each of the groups of embeddings separately based on corresponding quantization parameters of the different set of quantization parameters. Each of the embedding groups may be quantized according to the quantization parameters for its embedding group.

At block 610, the process 600 multiplies the quantized group of embeddings with a set of weights to generate an output. A matrix multiplication operation may be performed between the quantized embedding groups of the activation tensor and the weight matrix.

Implementation examples are provided in the following numbered clauses.
1. A processor-implemented method comprising:

receiving sequential data at a first layer of a transformer neural network;

processing the sequential data via attention layers of the transformer neural network to generate an activation tensor;

splitting the activation tensor into multiple groups of embeddings, each group of embeddings having a different set of quantization parameters;

quantizing each of the groups of embeddings separately based on corresponding quantization parameters of the different set of quantization parameters; and

multiplying the quantized group of embeddings with a set of weights to generate an output.
2. The processor-implemented method of clause 1, further comprising quantizing the set of weights.
3. The processor-implemented method of clause 1 or 2, in which the quantized groups of embeddings have a first precision and the quantized set of weights has a second precision, the first precision being less than the second precision.
4. The processor-implemented method of any of clauses 1-3, in which the sequential data includes at least a portion of a natural language sentence and the method further comprises determining an inference based on the output, the inference indicating an identification of the portion of the natural language sentence.
5. The processor-implemented method of any of clauses 1-4, further comprising:

determining for each embedding dimension a dynamic range; and

sorting the embeddings based on the dynamic range to form the multiple groups of embeddings.
6. The processor-implemented method of any of clauses 1-5, in which the different sets of quantization parameters and the set of weights are learned jointly.
7. The processor-implemented method of any of clauses 1-6, further comprising:

dividing the set of weights into multiple groups of weights corresponding to the multiple groups of embeddings;

multiplying each group of weights with a corresponding group of embeddings, each multiplication providing an additional output of a group of outputs; and

aggregating the group of outputs.
8. The processor-implemented method of any of clauses 1-7, further comprising:

determining a dynamic range for each embedding group; and

performing a permutation based on the dynamic range.
9. An apparatus comprising:

a memory; and

at least one processor coupled to the memory, the at least one processor being configured:
to receive sequential data at a first layer of a transformer neural network;
to process the sequential data via attention layers of the transformer neural network to generate an activation tensor;
to split the activation tensor into multiple groups of embeddings, each group of embeddings having a different set of quantization parameters;
to quantize each of the groups of embeddings separately based on corresponding quantization parameters of the different set of quantization parameters; and
to multiply the quantized group of embeddings with a set of weights to generate an output.
10. The apparatus of clause 9, in which the at least one processor is further configured to quantize the set of weights.
11. The apparatus of clause 9 or 10, in which the quantized groups of embeddings have a first precision and the quantized set of weights has a second precision, the first precision being less than the second precision.
12. The apparatus of any of clauses 9-11, in which the sequential data includes at least a portion of a natural language sentence and in which the at least one processor is further configured to determine an inference based on the output, the inference indicating an identification of the portion of the natural language sentence.
13. The apparatus of any of clauses 9-12, in which the at least one processor is further configured:

to determine for each embedding dimension a dynamic range; and

to sort the embeddings based on the dynamic range to form the multiple groups of embeddings.
14. The apparatus of any of clauses 9-13, in which the at least one processor is further configured to jointly learn the different sets of quantization parameters and the set of weights.
15. The apparatus of any of clauses 9-14, in which the at least one processor is further configured:

to divide the set of weights into multiple groups of weights corresponding to the multiple groups of embeddings;

to multiply each group of weights with a corresponding group of embeddings, each multiplication providing an additional output of a group of outputs; and

to aggregate the group of outputs.
16. The apparatus of any of clauses 9-15, in which the at least one processor is further configured:

to determine a dynamic range for each embedding group; and

to perform a permutation based on the dynamic range.
17. An apparatus comprising:

means for receiving sequential data at a first layer of a transformer neural network;

means for processing the sequential data via attention layers of the transformer neural network to generate an activation tensor;

means for splitting the activation tensor into multiple groups of embeddings, each group of embeddings having a different set of quantization parameters;

means for quantizing each of the groups of embeddings separately based on corresponding quantization parameters of the different set of quantization parameters; and

means for multiplying the quantized group of embeddings with a set of weights to generate an output.
18. The apparatus of clause 17, further comprising quantizing the set of weights.
19. The apparatus of clause 17 or 18, in which the quantized groups of embeddings have a first precision and the quantized set of weights has a second precision, the first precision being less than the second precision.
20. The apparatus of any of clauses 17-19, in which the sequential data includes at least a portion of a natural language sentence and the method further comprises determining an inference based on the output, the inference indicating an identification of the portion of the natural language sentence.
21. The apparatus of any of clauses 17-20, further comprising:

means for determining for each embedding dimension a dynamic range; and

means for sorting the embeddings based on the dynamic range to form the multiple groups of embeddings.
22. The apparatus of any of clauses 17-21, in which the different sets of quantization parameters and the set of weights are learned jointly.
23. The apparatus of any of clauses 17-22, further comprising:

dividing the set of weights into multiple groups of weights corresponding to the multiple groups of embeddings;

multiplying each group of weights with a corresponding group of embeddings, each multiplication providing an additional output of a group of outputs; and

aggregating the group of outputs.
24. The apparatus of any of clauses 17-23, further comprising:

determining a dynamic range for each embedding group; and

performing a permutation based on the dynamic range.
25. A non-transitory computer readable medium having encoded thereon program code, the program code being executed by a processor and comprising:

program code to receive sequential data at a first layer of a transformer neural network;

program code to process the sequential data via attention layers of the transformer neural network to generate an activation tensor;

program code to split the activation tensor into multiple groups of embeddings, each group of embeddings having a different set of quantization parameters;

program code to quantize each of the groups of embeddings separately based on corresponding quantization parameters of the different set of quantization parameters; and

program code to multiply the quantized group of embeddings with a set of weights to generate an output.
26. The non-transitory computer readable medium of clause 25, further comprising program code to quantize the set of weights.
27. The non-transitory computer readable medium of clause 25 or 26, in which the quantized groups of embeddings have a first precision and the quantized set of weights has a second precision, the first precision being less than the second precision.
28. The non-transitory computer readable medium of any of clauses 25-27, in which the sequential data includes at least a portion of a natural language sentence, and further comprising program code to determine an inference based on the output, the inference indicating an identification of the portion of the natural language sentence.
29. The non-transitory computer readable medium of any of clauses 25-28, further comprising:

program code to determine for each embedding dimension a dynamic range; and

program code to sort the embeddings based on the dynamic range to form the multiple groups of embeddings.
30. The non-transitory computer readable medium of any of clauses 25-29, further comprising:

program code to divide the set of weights into multiple groups of weights corresponding to the multiple groups of embeddings;

program code to multiply each group of weights with a corresponding group of embeddings, each multiplication providing an additional output of a group of outputs; and

program code to aggregate the group of outputs.

In one aspect, the receiving means, the processing means, splitting means, quantizing means, and/or the multiplying means may be the CPU 102, program memory associated with the CPU 102, the dedicated memory block 118, and or NPU 108 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method comprising:
receiving sequential data at a first layer of a transformer neural network;
processing the sequential data via attention layers of the transformer neural network to generate an activation tensor;
splitting the activation tensor into multiple groups of embeddings, each group of embeddings having a different set of quantization parameters;
quantizing each of the groups of embeddings separately based on corresponding quantization parameters of the different set of quantization parameters; and
multiplying the quantized group of embeddings with a set of weights to generate an output.

2. The processor-implemented method of claim 1, further comprising quantizing the set of weights.

3. The processor-implemented method of claim 2, in which the quantized groups of embeddings have a first precision and the quantized set of weights has a second precision, the first precision being less than the second precision.

4. The processor-implemented method of claim 1, in which the sequential data includes at least a portion of a natural language sentence and the method further comprises determining an inference based on the output, the inference indicating an identification of the portion of the natural language sentence.

5. The processor-implemented method of claim 1, further comprising:
determining for each embedding dimension a dynamic range; and
sorting the embeddings based on the dynamic range to form the multiple groups of embeddings.

6. The processor-implemented method of claim 1, in which the different sets of quantization parameters and the set of weights are learned jointly.

7. The processor-implemented method of claim 1, further comprising:
dividing the set of weights into multiple groups of weights corresponding to the multiple groups of embeddings;
multiplying each group of weights with a corresponding group of embeddings, each multiplication providing an additional output of a group of outputs; and
aggregating the group of outputs.

8. The processor-implemented method of claim 7, further comprising:
determining a dynamic range for each embedding group; and
performing a permutation based on the dynamic range.

9. An apparatus comprising:
a memory; and
at least one processor coupled to the memory, the at least one processor being configured:
to receive sequential data at a first layer of a transformer neural network;
to process the sequential data via attention layers of the transformer neural network to generate an activation tensor;
to split the activation tensor into multiple groups of embeddings, each group of embeddings having a different set of quantization parameters;
to quantize each of the groups of embeddings separately based on corresponding quantization parameters of the different set of quantization parameters; and
to multiply the quantized group of embeddings with a set of weights to generate an output.

10. The apparatus of claim 9, in which the at least one processor is further configured to quantize the set of weights.

11. The apparatus of claim 10, in which the quantized groups of embeddings have a first precision and the quantized set of weights has a second precision, the first precision being less than the second precision.

12. The apparatus of claim 9, in which the sequential data includes at least a portion of a natural language sentence and in which the at least one processor is further configured to determine an inference based on the output, the inference indicating an identification of the portion of the natural language sentence.

13. The apparatus of claim 9, in which the at least one processor is further configured:
to determine for each embedding dimension a dynamic range; and
to sort the embeddings based on the dynamic range to form the multiple groups of embeddings.

14. The apparatus of claim 9, in which the at least one processor is further configured to jointly learn the different sets of quantization parameters and the set of weights.

15. The apparatus of claim 9, in which the at least one processor is further configured:
to divide the set of weights into multiple groups of weights corresponding to the multiple groups of embeddings;
to multiply each group of weights with a corresponding group of embeddings, each multiplication providing an additional output of a group of outputs; and
to aggregate the group of outputs.

16. The apparatus of claim 15, in which the at least one processor is further configured:
to determine a dynamic range for each embedding group; and
to perform a permutation based on the dynamic range.

17. An apparatus comprising:
means for receiving sequential data at a first layer of a transformer neural network;
means for processing the sequential data via attention layers of the transformer neural network to generate an activation tensor;
means for splitting the activation tensor into multiple groups of embeddings, each group of embeddings having a different set of quantization parameters;
means for quantizing each of the groups of embeddings separately based on corresponding quantization parameters of the different set of quantization parameters; and
means for multiplying the quantized group of embeddings with a set of weights to generate an output.

18. The apparatus of claim 17, further comprising quantizing the set of weights.

19. The apparatus of claim 18, in which the quantized groups of embeddings have a first precision and the quantized set of weights has a second precision, the first precision being less than the second precision.

20. The apparatus of claim 17, in which the sequential data includes at least a portion of a natural language sentence and the method further comprises determining an inference based on the output, the inference indicating an identification of the portion of the natural language sentence.

21. The apparatus of claim 17, further comprising:
means for determining for each embedding dimension a dynamic range; and
means for sorting the embeddings based on the dynamic range to form the multiple groups of embeddings.

22. The apparatus of claim 17, in which the different sets of quantization parameters and the set of weights are learned jointly.

23. The apparatus of claim 17, further comprising:
dividing the set of weights into multiple groups of weights corresponding to the multiple groups of embeddings;
multiplying each group of weights with a corresponding group of embeddings, each multiplication providing an additional output of a group of outputs; and
aggregating the group of outputs.

24. The apparatus of claim 23, further comprising:
determining a dynamic range for each embedding group; and
performing a permutation based on the dynamic range.

25. A non-transitory computer readable medium having encoded thereon program code, the program code being executed by a processor and comprising:
program code to receive sequential data at a first layer of a transformer neural network;
program code to process the sequential data via attention layers of the transformer neural network to generate an activation tensor;
program code to split the activation tensor into multiple groups of embeddings, each group of embeddings having a different set of quantization parameters;
program code to quantize each of the groups of embeddings separately based on corresponding quantization parameters of the different set of quantization parameters; and
program code to multiply the quantized group of embeddings with a set of weights to generate an output.

26. The non-transitory computer readable medium of claim 25, further comprising program code to quantize the set of weights.

27. The non-transitory computer readable medium of claim 26, in which the quantized groups of embeddings have a first precision and the quantized set of weights has a second precision, the first precision being less than the second precision.

28. The non-transitory computer readable medium of claim 25, in which the sequential data includes at least a portion of a natural language sentence, and further comprising program code to determine an inference based on the output, the inference indicating an identification of the portion of the natural language sentence.

29. The non-transitory computer readable medium of claim 25, further comprising:
program code to determine for each embedding dimension a dynamic range; and
program code to sort the embeddings based on the dynamic range to form the multiple groups of embeddings.

30. The non-transitory computer readable medium of claim 25, further comprising:
program code to divide the set of weights into multiple groups of weights corresponding to the multiple groups of embeddings;
program code to multiply each group of weights with a corresponding group of embeddings, each multiplication providing an additional output of a group of outputs; and
program code to aggregate the group of outputs.
